(19) United States
(12) Patent Application Publication
(10) Pub. No.: US 2024/0178730 A1
(43) Pub. Date: May 30, 2024

(54) HEATING DEVICE FOR ROTOR CORE

(71) Applicant: TOYOTA JIDOSHA KABUSHIKI KAISHA, Toyota-shi (JP)

(72) Inventors: Hiroshi KIKUCHI, Toyota-shi (JP); Eiji SHIMIZU, Nisshin-shi (JP); Kenta CHIMATA, Toyota-shi (JP)

(73) Assignee: TOYOTA JIDOSHA KABUSHIKI KAISHA, Toyota-shi (JP)

(21) Appl. No.: 18/468,246

(22) Filed: Sep. 15, 2023

(30) Foreign Application Priority Data
Nov. 24, 2022 (JP) 2022-187535

(51) Int. Cl. H02K 15/12; H02K 1/28; H02K 11/01

(52) U.S. Cl. CPC H02K 15/12; H02K 1/28; H02K 11/012

(57) ABSTRACT

A heating device for induction-heating a rotor core of an electric motor includes an induction heating coil disposed in a central hole of the rotor core, an alternating current power supply for supplying an alternating current to the induction heating coil, and a first magnetic flux shielding plate disposed on a first end face of the rotor core and having a first opposing surface opposed to the first end face of the rotor core. The first opposing surface of the first magnetic flux shielding plate has a first inner region and a first outer region located radially outward of the first inner region. The first inner region protrudes more toward the first end face than the first outer region. Clearance is formed between the first outer region and the first end face of the rotor core when the first inner region abuts the first end face of the rotor core.

### CROSS-REFERENCE TO RELATED APPLICATION

This application claims priority to Japanese Patent Application No. 2022-187535 filed on Nov. 24, 2022, incorporated herein by reference in its entirety.

### BACKGROUND

### 1. Technical Field

The present specification relates to heating devices for induction-heating a rotor core.

### 2. Description of Related Art

Japanese Unexamined Patent Application Publication No. 2017-050169 (JP 2017-050169 A) discloses a rotor core heating device that heats a rotor core having a hollow cylindrical shape by high frequency heating using a coil disposed so as to face the inner peripheral surface of the rotor core. This rotor core heating device includes a pair of magnetic flux shielding jigs disposed on both axial end faces of the rotor core.

### SUMMARY

In the above heating device, the magnetic flux shielding jigs are configured to contact the entire axial end faces of the rotor core. With such a configuration, due to manufacturing variation of the rotor core or the magnetic flux shielding jigs, the magnetic flux shielding jigs may not be uniformly in close contact with the axial end faces of the rotor core. In particular, when there is a gap between the magnetic flux shielding jig and the axial end face of the rotor core around a through hole of the rotor core, the rotor core may be locally overheated due to unintended concentration of magnetic flux when induction-heated. The present specification provides a technique capable of avoiding or reducing such a problem.

The present specification is embodied in a heating device configured to induction-heat a rotor core of an electric motor. According to a first aspect, the rotor core includes a first end face, a second end face that is an opposite end face from the first end face in an axial direction, and a central hole extending in the axial direction from the first end face to the second end face. The heating device includes: an induction heating coil located in the central hole of the rotor core; an alternating current power supply electrically connected to the induction heating coil and configured to supply an alternating current to the induction heating coil; and a first magnetic flux shielding plate located on the first end face of the rotor core and including a first opposing surface facing the first end face of the rotor core.

The first opposing surface of the first magnetic flux shielding plate includes a first inner region and a first outer region located radially outward of the first inner region. The first inner region protrudes toward the first end face with respect to the first outer region. There is clearance between the first outer region and the first end face of the rotor core when the first inner region is in contact with the first end face of the rotor core.

According to the above configuration, the heating device includes the first magnetic flux shielding plate including the first opposing surface facing the first end face of the rotor core. The first opposing surface includes the first inner region and the first outer region located radially outward of the first inner region. The first inner region protrudes toward the first end face with respect to the first outer region. According to such a configuration, the rotor core and the first magnetic flux shielding plate can be in closer contact with each other in a central portion of the rotor core that is located adjacent to the central hole. As a result, local overheating of the rotor core is avoided or reduced.

According to a second aspect, in the first aspect, the first inner region of the first magnetic flux shielding plate may be in contact with an entire peripheral edge portion of the center hole in the first end face.

According to a third aspect, in the second aspect, the first magnetic flux shielding plate may have a through hole having an opening in a region surrounded by the first inner region. A diameter of the through hole of the first magnetic flux shielding plate may be smaller than a diameter of the center hole of the rotor core.

According to a fourth aspect, in the first aspect, the heating device may further include a second magnetic flux shielding plate located on the second end face of the rotor core and including a second opposing surface facing the second end face of the rotor core. The second opposing surface of the second magnetic flux shielding plate may include a second inner region and a second outer region located radially outward of the second inner region. The second inner region may protrude toward the second end face with respect to the second outer region and may be in contact with the second end face.

According to a fifth aspect, in the fourth aspect, the heating device may further include a pressing device configured to press toward the rotor core either or both of the first magnetic flux shielding plate located on the first end face of the rotor core and the second magnetic flux shielding plate located on the second end face of the rotor core.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a state in which a rotor core is set in a heating device of a first embodiment.

FIG. 2 is a perspective view of a magnetic flux shielding plate;

FIG. 3 is a partial top view of a rotor core;

FIG. 4A is a variety of charts;

FIG. 4B is a variety of charts;

FIG. 4C are various graphs; and

FIG. 5 is a cross-sectional view of a heating device of a second embodiment with a rotor core set.

### DETAILED DESCRIPTION OF EMBODIMENTS

### First Embodiment

The heating device 2 of the present embodiment is a device for induction heating the rotor core 10. The rotor core 10 is mounted on a shaft (not shown) to constitute a rotor of an electric motor. The rotor of the electric motor is rotatably held in a case of the electric motor. Typically, the electric motor further comprises a stator housed in the case. The stator is arranged to surround the rotor with clearance therebetween. The electric motor is employed, for example, as a motor for driving an electrified vehicle.

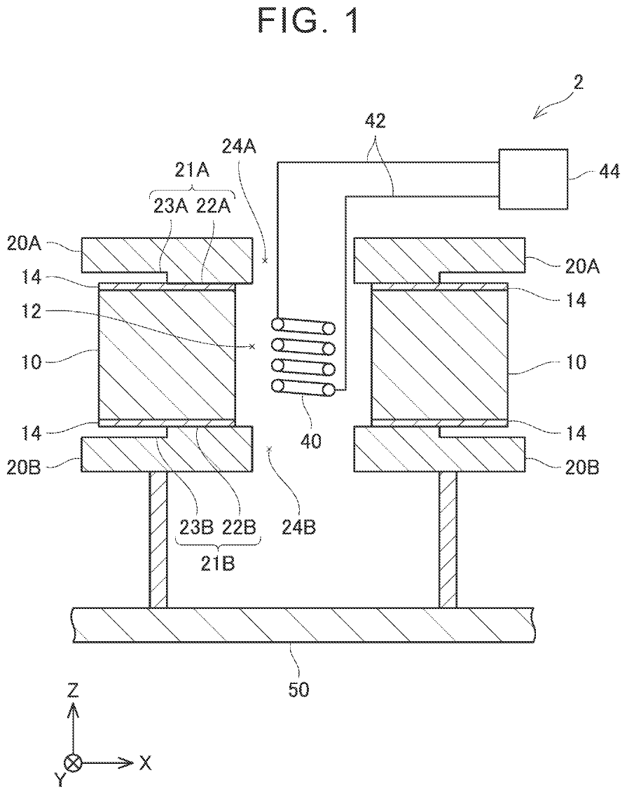

As shown in FIG. 1, the rotor core 10 includes a first end face 10A and a second end face 10B. The second end face 10B is located opposite to the first end face 10A in the axial direction (that is, the Z-axis direction in the drawing). The rotor core 10 further comprises a center hole 12. The center hole 12 extends axially from the first end face 10A to the second end face 10B.

The rotor core 10 further includes a pair of non-magnetic plates 14. The pair of non-magnetic plates 14 is located on the first end face 10A and the second end face 10B. Each non-magnetic plate 14 is made of, for example, stainless steel. Although not shown in FIG. 1, the rotor core 10 has a configuration in which a plurality of steel plates is laminated between the first end face 10A and the second end face 10B. The non-magnetic plate 14 disposed on the first end face 10A is welded and fixed to the first end face 10A at a plurality of weld points W (see FIG. 3). Further, the non-magnetic plate 14 disposed on the second end face 10B is welded and fixed to the second end face 10B at a plurality of weld points W. A point M in FIG. 3 is a position near the weld point W, and indicates a strain measurement place to be described later.

As shown in FIG. 3, the rotor core 10 is provided with a plurality of magnet holes 16. Permanent magnets 18 are respectively inserted into the plurality of magnet holes 16. The plurality of magnet holes 16 are arranged in the circumferential direction along the outer edge portion of the rotor core 10. Each magnet hole 16 extends in the axial direction. The permanent magnet 18 in the magnet hole 16 is fixed by resin, for example.

The heating device 2 of the rotor core 10 heats the rotor core 10 by Induction Heating (IH). As shown in FIG. 1, the heating device 2 includes an induction heating coil 40. The induction heating coil 40 is disposed in the center hole 12 of the rotor core 10. The induction heating coil 40 is electrically connected to an induction heating oscillation power supply 44 via a cable 42. The induction heating oscillation power supply 44 is an alternating current power supply that supplies an alternating current to the induction heating coil 40. By supplying an alternating current to the induction heating coil 40, the rotor core 10 is induction-heated. The heating device 2 is used to heat the rotor core 10 before shrink-fitting the rotor core 10 to the shaft.

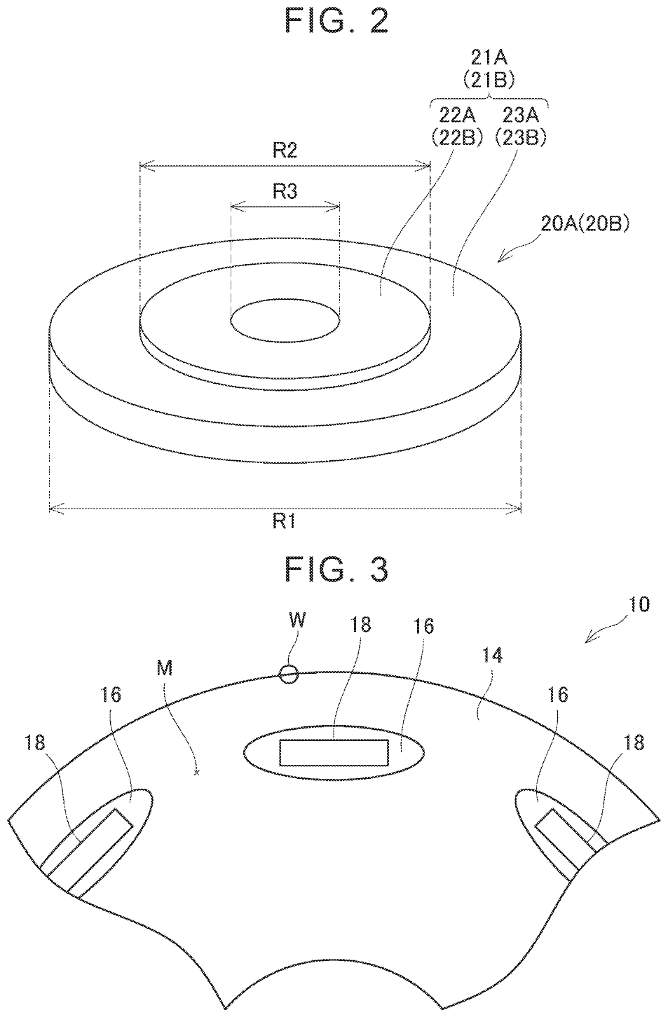

The heating device 2 includes a first magnetic flux shielding plate 20A disposed on the first end face 10A. As shown in FIGS. 1 and 2, the first magnetic flux shielding plate 20A has an opposing surface 21A facing the first end face 10A. The opposing surface 21A has an inner region 22A and an outer region 23A located radially outward of the inner region 22A. The inner region 22A protrudes more toward the first end face 10A than the outer region 23A. As shown in FIG. 2, the radial dimension of the first magnetic flux shielding plate 20A is R1, the radial dimension of the inner region 22A is R2. Although not particularly limited, in the present embodiment, R2 is half R1. In a variant, R2 may be greater than or less than half R1.

The first magnetic flux shielding plate 20A further includes a through-hole 24A. The through-hole 24A has an opening in the inner region 22A, and the radial dimension of the through-hole 24A is R3, as shown in FIG. 2, which is coaxially located with the inner region 22A. As shown in FIG. 1, the radial dimension R3 (not shown in FIG. 1) of the through-hole 24A is smaller than the radial dimension of the center hole 12 of the rotor core 10. The inner region 22A is in contact with the entire periphery of the center hole 12 in the first end face 10A of the rotor core 10. When the inner region 22A abuts on the first end face 10A of the rotor core 10, clearance is formed between the outer region 23A and the first end face 10A of the rotor core 10.

The heating device 2 further includes a second magnetic flux shielding plate 20B disposed on the second end face 10B. The second magnetic flux shielding plate 20B has the same configuration as that of the first magnetic flux shielding plate 20A. That is, the second magnetic flux shielding plate 20B has an opposing surface 21B facing the second end face 10B of the rotor core 10, and the opposing surface 21B has an inner region 22B and an outer region 23B. The inner region 22B protrudes more toward the second end face 10B than the outer region 23B. Further, the second magnetic flux shielding plate 20B has a through-hole 24B, the through-hole 24B has an opening in the inner region 22B. As shown in FIG. 1, the second magnetic flux shielding plate 20B disposed on the second end face 10B, the first magnetic flux shielding plate 20A disposed on the first end face 10A and the direction of the vertical direction (i.e., the Z-axis direction) is opposite.

The second magnetic flux shielding plate 20B is supported by the base portion 50 from the side opposed to the opposing surface 21B. Since the second magnetic flux shielding plate 20B is supported by the base portion 50, the rotor core 10 is loaded with the weight of the first magnetic flux shielding plate 20A. The weight of the first magnetic flux shielding plate 20A presses the rotor core 10 in the Z-axis negative direction (i.e., the downward direction in the drawing). As a result, one non-magnetic plate 14 of the rotor core 10 and the first magnetic flux shielding plate 20A are in close contact with each other, and the other non-magnetic plate 14 of the rotor core 10 and the second magnetic flux shielding plate 20B are in close contact with each other.

In particular, in the heating device 2 of the present embodiment, each of the first magnetic flux shielding plate 20A and the second magnetic flux shielding plate 20B has an inner region 22A, 22B protruding toward the rotor core 10, and contacts the rotor core 10 only in the inner region 22A, 22B. As a result, a pressing force strongly acts on the rotor core 10 at a center part adjoining the center hole 12 (that is, the entire periphery of the center hole 12 in the first end face 10A and the entire periphery of the center hole 12 in the second end face 10B). As a consequence, it is possible to prevent a gap from being formed between the non-magnetic plate 14 and the magnetic flux shielding plate 20A, 20B in the central part adjoining the center hole 12.

Here, a comparative example in which a conventional magnetic flux shielding plate is used in induction heating of the rotor core 10 will be assumed. In the above embodiment, the magnetic flux shielding plate 20A, 20B is provided with an inner region 22A. 22B protruding toward the rotor core 10. On the other hand, in the conventional magnetic flux shielding plate as a comparative example, the opposing surface facing the rotor core is formed flat.

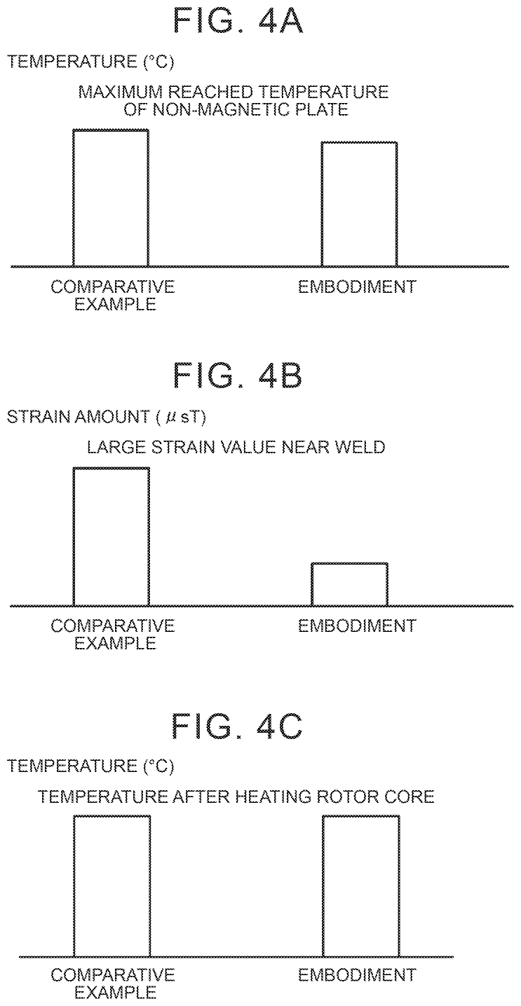

In FIGS. 4A to C, the index measured by induction heating of the comparative example and the index measured by induction heating of the present example are compared with each other. In particular, FIG. 4A shows the maximum attainable temperature of the non-magnetic plate 14. FIG. 4B show the maximal strain at point M in FIG. 3 (i.e. in the vicinity of the weld point W). FIG. 4C shows the temperature of the rotor core 10 after induction heating (the temperature after heating). In each of FIGS. 4A to 4C, the graph on the left shows a comparative example, and the graph on the right shows the present example.

As shown in FIG. 4A, according to the configuration of the present embodiment, the maximum reaching temperature of the non-magnetic plate 14 can be made lower than that of the comparative example. This is because of the following reasons. When an alternating current is supplied to the induction heating coil 40, a magnetic flux is generated. If the adhesion between the non-magnetic plate 14 and the magnetic flux shielding plate 20A, 20B is poor, this magnetic flux is concentrated on the non-magnetic plate 14. As a consequence, the non-magnetic plate 14 is overheated, and the maximum temperature reached by the non-magnetic plate 14 is relatively high (see the graph on the left side of FIG. 4A). On the other hand, as described above, in the heating device 2 of the present embodiment, it is possible to enhance the adhesion between the non-magnetic plate 14 and the magnetic flux shielding plate 20A, 20B. Therefore, according to the configuration of the present embodiment, as compared with the configuration of the comparative example, overheating of the non-magnetic plate 14 is suppressed, it is possible to lower the maximum reaching temperature of the non-magnetic plate 14 (see the graph on the right side of FIG. 4A).

Further, as shown in FIG. 4B, according to the configuration of the present embodiment, the maximum strain at the point M of the non-magnetic plate 14 can be made smaller than the configuration of the comparative example. This is because of the following reasons. When the non-magnetic plate 14 is overheated, a relatively large force is applied to a radially outer portion of the rotor core 10 (for example, in the vicinity of a welded portion where the first end face 10A of the rotor core 10 and the non-magnetic plate 14 are welded). Due to this force, the maximum strain in the vicinity of the weld of the non-magnetic plate becomes relatively large (see the graph on the left side of FIG. 4B). On the other hand, as described above, according to the configuration of the present embodiment, it is possible to lower the maximum reaching temperature of the non-magnetic plate 14 as compared with the configuration of the comparative example. Therefore, according to the configuration of the present embodiment, compared with the configuration of the comparative example, it is possible to reduce the force applied to the vicinity of the welded portion of the non-magnetic plate 14 (that is, the point M in FIG. 3). As a result, according to the configuration of the present embodiment, it is possible to reduce the maximum strain value in the vicinity of the welded portion of the non-magnetic plate 14 (that is, the point M in FIG. 3) as compared with the configuration of the comparative example.

Further, as shown in FIG. 4C, according to the configuration of the present embodiment, the temperature after the heating of the rotor core 10 is substantially the same as the temperature after the heating of the rotor core according to the configuration of the comparative example. That is, the rotor manufactured by the heating device 2 of the present embodiment has the same performance as the rotor manufactured by the heating device of the comparative example. Therefore, according to the configuration of the present embodiment, as compared with the configuration of the comparative example, it is possible to manufacture a rotor having the same performance as the rotor according to the configuration of the comparative example while reducing the maximum reaching temperature and the maximum strain value of the non-magnetic plate.

### Second Embodiment

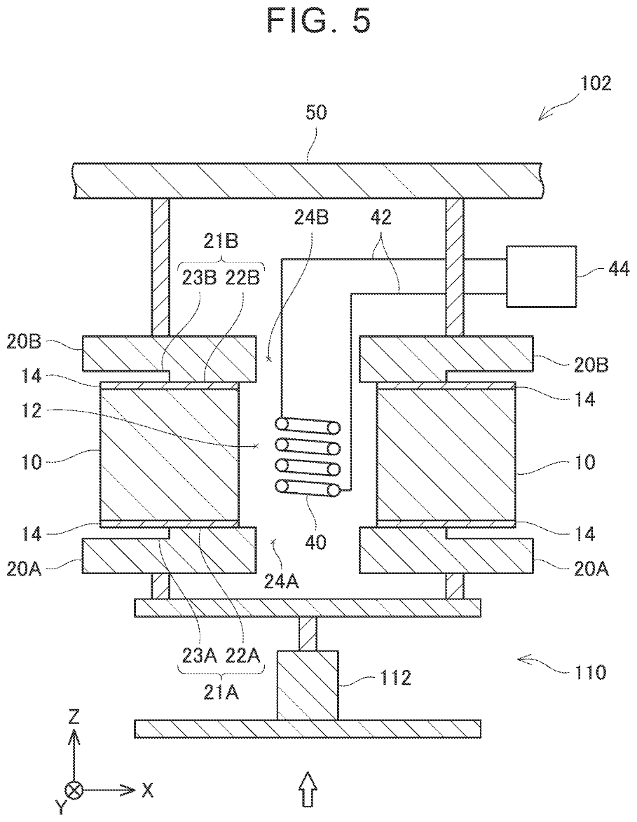

Next, a second embodiment will be described with reference to FIG. 5. The heating device 102 of the second embodiment is configured to be opposite to the heating device 2 of the first embodiment in the Z-axis direction (that is, the base portion 50 is positioned on the upper side in the drawing). In FIG. 5, the same components as those in FIG. 1 are denoted by the same reference numerals, and a detailed description thereof will be omitted.

The heating device 102 of the second embodiment further includes a pressing device 110. The pressing device 110 is disposed so as to face a surface (not shown) of the first magnetic flux shielding plate 20A facing the opposing surface 21A. The pressing device 110 comprises an actuator 112. As shown by the arrow in FIG. 5, the pressing device 110 presses the rotor core 10 in the positive Z-axis direction. Therefore, it is possible to further enhance the adhesion between the non-magnetic plate 14 and the magnetic flux shielding plate 20A, 20B.

### Correspondence

The induction heating oscillation power supply 44 corresponds to an example of an “alternating current power supply” of the present technology. The opposing surface 21A, the inner region 22A, and the outer region 23A correspond to exemplary “first opposing surface”, “first inner region”, and “first outer region”, respectively. The opposing surface 21B, the inner region 22B, and the outer region 23B correspond to exemplary “second opposing surface”, “second inner region”, and “second outer region”, respectively, of the present technique.

Although the specific examples disclosed by the present disclosure have been described in detail above, these are merely examples and do not limit the scope of claims. The techniques described in the claims include various modifications and alternations of the specific example illustrated above. Modifications of the above-described embodiment are listed below.

### First Modification

In the above embodiments, the first magnetic flux shielding plate 20A facing the first end face 10A of the rotor core 10 is provided, and the second magnetic flux shielding plate 20B facing the second end face 10B of the rotor core 10 is provided. That is, in the above embodiments, the heating device 2, 102 includes two magnetic flux shielding plate 20A, 20B. On the other hand, in the modification, only the first magnetic flux shielding plate 20A facing the first end face 10A of the rotor core 10 may be provided. Similarly, only the second magnetic flux shielding plate 20B facing the second end face 10B of the rotor core 10 may be provided. That is, the heating device 2, 102 may be configured to include only one magnetic flux shielding plate 20A (or 20B).

### Second Modification

The heating device 102 of the second embodiment may include a pressing device instead of the base portion 50. In this case, the rotor core 10 can be pressed from both sides in the Z-axis direction (i.e., the upper side and the lower side of the paper surface), so that the adhesion between the non-magnetic plate 14 and the magnetic flux shielding plate 20A, 20B can be further enhanced.

The technical elements described in the present specification or drawings exhibit technical usefulness alone or in various combinations, and are not limited to the combinations described in the claims at the time of filing. In addition, the techniques illustrated in the present specification or drawings can achieve a plurality of objectives at the same time, and achieving one of the objectives itself has technical usefulness.

What is claimed is:

1. A heating device configured to induction-heat a rotor core of an electric motor,
the rotor core including
a first end face,
a second end face that is an opposite end face from the first end face in an axial direction, and
a central hole extending in the axial direction from the first end face to the second end face,
the heating device comprising:
an induction heating coil located in the central hole of the rotor core;
an alternating current power supply electrically connected to the induction heating coil and configured to supply an alternating current to the induction heating coil; and
a first magnetic flux shielding plate located on the first end face of the rotor core and including a first opposing surface facing the first end face of the rotor core, wherein
the first opposing surface of the first magnetic flux shielding plate includes a first inner region and a first outer region located radially outward of the first inner region,
the first inner region protrudes toward the first end face with respect to the first outer region, and
there is clearance between the first outer region and the first end face of the rotor core when the first inner region is in contact with the first end face of the rotor core.

2. The heating device according to claim 1, wherein the first inner region of the first magnetic flux shielding plate is in contact with an entire peripheral edge portion of the center hole in the first end face.

3. The heating device according to claim 2, wherein:
the first magnetic flux shielding plate has a through hole having an opening in a region surrounded by the first inner region; and
a diameter of the through hole of the first magnetic flux shielding plate is smaller than a diameter of the center hole of the rotor core.

4. The heating device according to claim 1, further comprising a second magnetic flux shielding plate located on the second end face of the rotor core and including a second opposing surface facing the second end face of the rotor core, wherein:
the second opposing surface of the second magnetic flux shielding plate includes a second inner region and a second outer region located radially outward of the second inner region; and
the second inner region protrudes toward the second end face with respect to the second outer region and is in contact with the second end face.

5. The heating device according to claim 4, further comprising a pressing device configured to press toward the rotor core either or both of the first magnetic flux shielding plate located on the first end face of the rotor core and the second magnetic flux shielding plate located on the second end face of the rotor core.
